(19) United States
(12) Patent Application Publication
(10) Pub. No.: US 2010/0229738 A1
(43) Pub. Date: Sep. 16, 2010

(54) EMBOSS DEVICE

(75) Inventors: Kenichi Hirota, Tokyo-to (JP); Masayuki Nagashima, Tokyo-to (JP); Mineaki Etou, Tokyo-to (JP); Tomohiko Anazawa, Tokyo-to (JP); Satoshi Ueda, Tokyo-to (JP)

Correspondence Address: LADAS & PARRY LLP, 224 SOUTH MICHIGAN AVENUE, SUITE 1600, CHICAGO, IL, 60604, US

(73) Assignee: DAI NIPPON PRINTING CO., LTD., Tokyo (JP)

(21) Appl. No.: 12/294,458

(22) PCT Filed: Mar. 16, 2007
(86) PCT No.: PCT/JP2007/055432

§ 371 Date: Nov. 18, 2008

(30) Foreign Application Priority Data
Mar. 30, 2006 (JP) 2006-093219
Mar. 30, 2006 (JP) 2006-093223

(51) Int. Cl. B41F 19/02

(52) U.S. Cl. 101/22

(57) ABSTRACT

An emboss device including an emboss roller having a surface on which convexoconcave are formed; and an opposed roller arranged oppositely to the emboss roller. The emboss roller and the opposed roller sandwich a sheet-like print object, thereby to impart convexoconcave to the print object. The spacing d between the protruded part of the surface of the emboss roller and the surface of the opposed roller is set to 50 μm to 200 μm.

### TECHNICAL FIELD

The present invention relates to an emboss device of imparting convexoconcave to a sheet-like print object, or relates to an emboss device for a sheet-like print object, and particularly to an emboss device able to prevent curl of a sheet-like print object to which convexoconcave are imparted by embossing.

### RELATED ART

Some print object such as a photograph has a surface with moderated glossiness. In a case of silver salt photograph, image is printed on a photographic paper having a surface on which convexoconcave are imparted, so that a print object is obtained in a so-called silky tone with moderated glossiness. On the contrary, when a matte print object with moderated glossiness is to be obtained by using a sublimation thermal transfer printer, it is inapplicable to impart convexoconcave to an image receiving sheet prior to forming image on the sheet, unlike the case of silver salt photography. Thus, it is necessary to impart convexoconcave to a print object on which image has been formed.

In this circumstance, a device of imparting convexoconcave to a print object on which image has been formed is known as an emboss device. The device has an emboss roller having a surface on which convexoconcave are formed and incorporating a heating device; and an opposed roller arranged oppositely to the emboss roller. These rollers sandwich an image receiving sheet on which image has been formed with thermal transfer, so that convexoconcave are imparted to the image forming surface of the image receiving sheet (See Patent document 1, for example).

Moreover, convexoconcave are imparted to a print object with a heated emboss roller in the process of imparting the convexoconcave. Accordingly, the embossed side of the print object gets expanded or contracted due to heat, so that the printing paper is bent, namely, curled. The print object curled in this manner is unfavorable as a product, and may also cause feeding errors in the later processes.

Conventionally, some printer or the like for a print object has a mechanism of correcting curl of a print object. For example, one such a curl correcting mechanism includes a deformable roller and an opposed roller, and makes a print object to pass through between the rollers so as to curl it in a reverse direction, thereby to correct curl (See patent document 2). In one curl correcting mechanism, two curl correcting rollers are pressed against the outer peripheral surface of the convey roller, and a print object is made to pass through therebetween. In one curl correcting mechanism, a curl correcting belt is wound between a pair of pulleys, a part of the curl correcting belt is pressed against the outer peripheral surface of the convey roller, and a print object is made to pass through therebetween. Moreover, in one curl correcting mechanism, a print object is made to pass through between curved guides (See patent document 3). In one curl correcting mechanism, a printing paper rolled in a shape of a roll is pressed in the opposite direction to the direction of curl when the paper is ejected out (See patent document 4).

Patent document 1: JP62-198857A

Patent document 2: JP2000-143067A

Patent document 3: JP7-267454A

patent document 4: JP2910345B

### SUMMARY OF INVENTION

### Problems to be Solved by the Invention

In a conventional emboss device, an appropriate range of spacing between both rollers, elasticity or thickness of rubber, or pressure between both rollers is sometimes unclear, so that glossiness of an image receiving sheet can not be reduced to a desirable range thereof, or an image receiving sheet may have uneven glossiness, and an image receiving sheet can be further damage.

Moreover, such a curl preventing mechanism is a mechanism of correcting curl by forcibly bending an already curled print object in the reverse direction. Accordingly, in some cases when curl is corrected, skew may be generated on the image printing surface or curl can not be corrected enough.

It is an object of the present invention to provide an emboss device able to evenly reduce glossiness of an image receiving sheet to a desirable range thereof without damaging it. Also, it is another object of the present invention to provide an emboss device with which an embossed print object can be obtained in a condition without skew and curl.

### Means for Solving Problem

An emboss device according to an embodiment of the present invention includes an emboss roller having a surface on which convexoconcave are formed; and an opposed roller arranged oppositely to the emboss roller, wherein the emboss roller and the opposed roller sandwich a sheet-like print object therebetween, thereby to impart the print object with convexoconcave, and the spacing between the protruded part of the surface of the emboss roller and the surface of the opposed roller is 50 μm to 200 μm. Thus, the emboss device solves the above problem.

According to the emboss device, the spacing between the protruded part of the surface of the emboss roller and the surface of the opposed roller is equal to or more than 50 μm. Thus, it does not occur that the print object can not be passed therethrough. Moreover, since the spacing is equal to or less than 200 μm, it does not occur that glossiness of the print object is insufficiently reduced owing that it is insufficient embossed.

Furthermore in this case, the opposed roller may include a cylindrical member and an elastic member wrapped around the outer periphery of the cylindrical member, the elastic member may be 35° to 70° in hardness and 200 μm to 800 μm in thickness, and the print object may be 220 μm to 250 μm in thickness.

Furthermore, an emboss device according to an embodiment of the present invention includes an emboss roller having a surface on which convexoconcave are formed; and an opposed roller arranged oppositely to the emboss roller, wherein the emboss roller and the opposed roller sandwich a sheet-like print object therebetween, thereby to impart the print object with convexoconcave, the opposed roller includes a cylindrical member and an elastic member wrapped around the outer periphery of the cylindrical member, and the elastic member is 200 μm to 800 μm in thickness. Thus, the emboss device solves the above problem.

According to the emboss device, the elastic member wrapped around the outer periphery of the opposed roller is thicker than 200 μm in thickness. Thus, it does not occur that convexoconcave are unevenly imparted owing to insufficient elasticity. Moreover, since the elastic member is thinner than 800 μm, it does not occur that the print object is pressed against the emboss roller with insufficient pressing force owing to excess elasticity and that thus glossiness reaches equal to or more than 60.

Furthermore in this case, the elastic member may be 60° in hardness and 200 μm to 500 μm in thickness, the spacing between the protruded part of the surface of the emboss roller and the surface of the elastic member wrapped around the opposed roller may be 50 μm to 200 μm, and the print object may be about 220 μm to 250 μm in thickness.

Furthermore, the emboss device of the present invention includes an emboss roller having a surface on which convexoconcave are formed and an opposed roller arranged oppositely to the emboss roller, wherein the emboss roller and the opposed roller sandwich a sheet-like print object therebetween, thereby to impart the print object with convexoconcave, the emboss device is configured in that the pressure applied to the print object is set to more than 8 MPa and less than 14 MPa when the print object is sandwiched between the emboss roller and the opposed roller. Thus, the emboss device solves the above problem.

According to the emboss device, the pressure applied to the print object is more than 8 MPa. Thus, it does not occur that the print object is pressed against the emboss roller with insufficient pressing force and that thus the glossiness of the print object reaches equal to or more than 60. Moreover, since the pressure applied to the print object is less than 14 MPa, it does not occur that the print object is damaged owing to excess pressing force or it does not occur that convexoconcave are unevenly imparted. Accordingly, glossiness can be evenly reduced.

Furthermore in this case, the spacing between the protruded part of the surface of the emboss roller and the surface of the opposed roller may be 50 μm to 200 μm, the elastic member may be 50° to 70° in hardness, and the print object may be about 220 μm to 250 μm in thickness.

An emboss device according to another embodiment of the present invention includes an emboss roller having a surface on which convexoconcave are formed and a heating device, and an opposed roller arranged oppositely from the emboss roller, wherein the emboss roller heated by the heating device and the opposed roller sandwich a sheet-like print object therebetween, thereby to impart the print object with convexoconcave. The emboss device includes a curl preventing guide provided with a gap at the downstream side of a part between the emboss roller and the opposed roller with respect to the feed direction of the print object, the part imparting convexoconcave to the print object, wherein the gap extends along the feed direction of the print object, and the print object is loaded into the gap at a substantially flat condition.

Just after embossing, the print object which is passed through and embossed between the heated emboss roller and the opposed roller is still in a state of elevated temperature. According to the present invention, the print object in a condition of elevated temperature and in a condition that curl is still unfixed is loaded into the gap of the curl preventing guide at the downstream side in a substantially flat condition. Then, the print object is conveyed in the gap in the flat condition, during which it is cooled down naturally. Thus, the print object ejected from the curl preventing guide becomes in a flat condition without curl.

Furthermore, in another embodiment of the present invention, the gap may stretch out in the thickness direction of the print object loaded into the gap at an upstream end thereof. Accordingly, even if the print object conveyed from between the emboss roller and the opposed roller is somewhat curled, the upstream end part of the gap which serves as an entry part to the gap is stretched out in the thickness direction of the print object. Thus, the print object can be easily inserted into the gap.

In another embodiment of the present invention, the curl preventing guide may include two flat plates extending in parallel to each other along a feed direction of the print object, and the gap may be formed from the clearance between the two flat plates. Accordingly, the gap is formed from the clearance between the two parallel flat plates, and thus the emboss device in a compact form can be easily manufactured.

In another embodiment of the present invention, a paper eject tray of holding a print object ejected from the curl preventing guide may be disposed at the downstream of the curl preventing guide with respect to a feed direction of the print object, and the paper eject tray may hold the print object curled in a manner that the middle portion of the print object is curled convexedly with respect to a placing surface of the paper eject tray. Accordingly, even when the print object ejected from the curl preventing guide is curled, the curl can be corrected by the own weight of the print object while the print object is held on the paper eject tray in a manner that the middle portion of the print object is convexed.

### EFFECT OF INVENTION

As described above, according to the emboss device of the present invention, a print object evenly has a glossiness of equal to or less than 60. Thus, a print object having a brilliant silky tone with moderated gloss can be obtained. Moreover, after embossing, the print object is kept in a state unable to be curled while it is cooled down so as to be flattened. Accordingly, a flat print object without skew on its surface can be obtained.

### BRIEF DESCRIPTION OF DRAWINGS

FIG. 1 is a schematic view of an emboss device according to an embodiment of the present invention.

FIG. 2 is an enlarged view of a part of the emboss device including an emboss roller and an opposed roller according to an embodiment of the invention.

FIG. 3 is a schematic view of an emboss device according to another embodiment of the present invention.

FIG. 4 is an enlarged view of the surrounding of a curl preventing guide.

FIG. 5 is a schematic perspective view of the curl preventing guide.

FIG. 6 is a view a view of an arrangement in which an emboss roller is arranged on the lower side and an opposed roller is arranged on the upper side.

FIG. 7 is a view of an arrangement in which an emboss roller is arranged on the upper side and an opposed roller is arranged on the lower side.

### BEST MODE FOR CARRYING OUT THE INVENTION

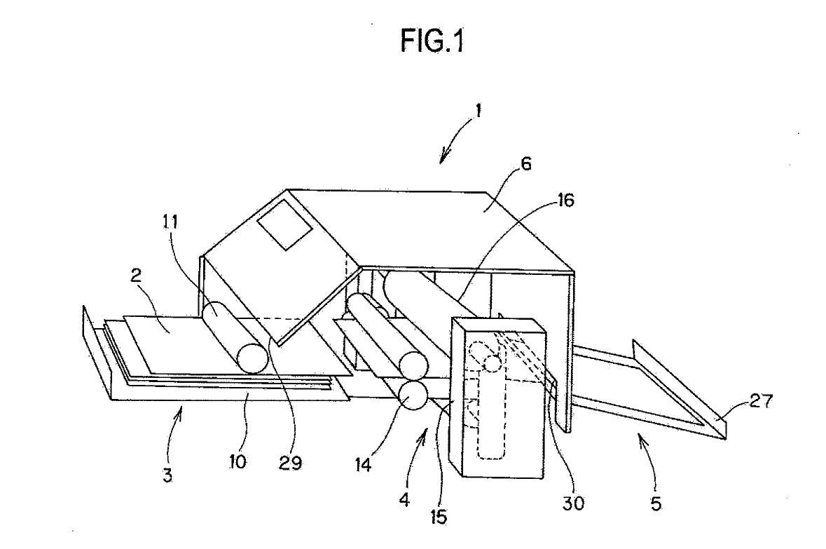

FIG. 1 shows a schematic view of an emboss device 1 according to an embodiment of the present invention. The emboss device 1 is a device of applying pressure to a print object 2, which is a sheet-like object to be processes, so that convexoconcave are imparted to the surface of the print object 2. In this embodiment, the print object 2 is a photograph in which image is transferred to an image receiving sheet having paper as its base material and the surface of the sheet is covered with a protection layer. The emboss device 1 is a device of imparting convexoconcave to the protection layer side surface (image forming surface) of a print object 2, thereby to process the print object 2 into a matt condition with moderated gloss.

The emboss device 1 has a holder 3 of holding an unprocessed print object 2, a process part 4 of embossing the print object 2 conveyed from the holder 3, an ejection part 5 of ejecting the processed print object 2, and a chassis 6 of surrounding the process part 4 side of the holder 3 and the process part 4.

The holder 3 includes a paper feed tray 10 able to hold multiple sheets of print object 2 in a stacked form, and a pickup roller 11 of feeding out the print objects 2 placed on the paper feed tray 10 one by one toward the process part 4. It is noted that the pickup roller 11 is adapted to be rotated by a drive mechanism not shown in the figure.

The process part 4 includes a pair of cleaning rollers 14 which remove smear such as dust from the print object 2 fed by the pickup roller 11 and convey the print object 2 further to the downstream. It is noted that the cleaning rollers 14 are also adapted to be rotated by drive mechanisms not shown in the figure. Then, the process part 4 includes an emboss roller 15 and an opposed roller 16 paired with the emboss roller 15 at the further downstream side. The emboss roller 15 and the opposed roller 16 sandwich the print object 2 conveyed by the cleaning rollers 14 therebetween and emboss the print object 2.

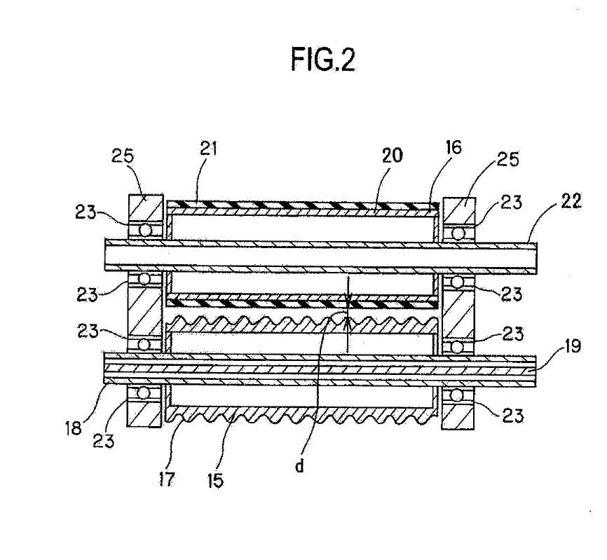

FIG. 2 is a schematic cross-sectional view of the emboss roller 15 and the opposed roller 16 in an enlarged manner. The emboss roller 15 is a cylindrical member formed of a hollow material made by aluminum or the like, and has a surface on which convexoconcave 17 are formed as illustrated schematically in FIG. 2. Then, a rotation shaft 18 is loaded into the center of the emboss roller 15 along its longitudinal direction. A heating mechanism 19 able to set the surface temperature within a prescribed range of temperature is provided inside the rotation shaft 18. The heating mechanism 19 includes a heating body such as a heater and can set the surface temperature of the emboss roller 15 by setting the heat amount of the heater appropriately. Furthermore, a drive mechanism not shown in the figure is connected to the emboss roller 15, and the emboss roller 15 is rotated by the drive mechanism. The opposed roller 16 includes a cylindrical member 19 formed of a hollow material made by aluminum or the like and an elastic member 21 wrapped around the outer periphery of the cylindrical member in a similar manner to the emboss roller 15. Rubber is used in this embodiment as the elastic member, however; it is not limited to rubber. The elastic member may be a member having cushioning properties. Moreover, a rotation shaft 20 is further loaded into the center of the opposed roller 16 along its longitudinal direction in a similar manner to the emboss roller 15. The rotation shafts 18,20 of the emboss roller 15 and the opposed roller 16 are secured to supporting plates 25 via bearings 23 provided at both ends of both rollers 15,16 in a rotatable manner with respect to the supporting plates and in parallel to each other. Moreover, the spacing between the protruded part of the surface of the emboss roller 15 and the surface of the rubber 21 of the opposed roller 16 is maintained to be a prescribed spacing d, which will be described later.

Return to FIG. 1, the ejection part 5 of the emboss device 1 includes a paper eject tray 27 for receiving the embossed print object conveyed from the process part 4. Moreover, the chassis 6 surrounds the process part 4 side of the holder 3 and the process part 4 as described above, and has an entry 29 and an exit 30. When a print object 2 is placed on the paper feed tray 10, the print object 2 is held in a manner that a part of the print object 2 is inserted from the entry 29 into the interior of the chassis 6.

In the emboss device 1, a print object 2 is first placed on the paper feed tray 10 of the holder 3 with its protection layer side surface (image forming surface) down. Accordingly, the print object 2 is held in a manner that a part of the print object 2 is inserted from the entry 29 into the interior of the chassis 6 as described above. When the emboss device 1 is in operation, the pickup roller 11 is rotated in contact with the print object 2, so that the print object 2 is fed one by one to the process part 4 inside the chassis 6. The print object 2 conveyed to the process part 4 is sandwiched and conveyed between the cleaning rollers 14 rotated by drive mechanisms, during which dust or the like is removed from the print object 2. The print object 2 is fed into between the emboss roller 15 and the opposed roller 16. Then, when the print object 2 passes through between the emboss roller 15 and the opposed roller 16, minute convexoconcave are imparted to the surface of the print object 2 by the convexoconcave on the emboss roller 15, and thus the print object 2 is processed in a matt condition with moderated gloss. Then, after embossing of the print object 2 is finished, it is ejected from the exit 30 and is held on the paper eject tray 27.

Next, the spacing d between the protruded part of the surface of the emboss roller 15 and the surface of the rubber 21 of the opposed roller 16 in an embodiment of the present invention will be described. First, the spacing d at which glossiness in a desirable range can be accomplished is obtained from the following experiments. A printing paper having a thickness of about 220 μm to 250 μm is fabricated as a print object 2 by MEGAPIXEL III sublimation transfer printer made by ALTECH Co., Ltd. The printing paper is passed through and embossed in the emboss device 1 of the present invention with varying the spacing d between the protruded part of the surface of the emboss roller 15 and the surface of the rubber 21 of the opposed roller 16 under a condition when radius of both rollers 15,16 is 300 mm, type of the rubber wrapped around the opposed roller 16 is chloroprene, hardness of the rubber is 60° (JIS-A), thickness of the rubber is 300 μm, process speed of the print object is 10 mm/s, pressure is 9 MPa, surface roughness Ra of the emboss roller 15, Ra=8 μm, and surface temperature is 80° C. The glossiness of the embossed print object 2 is measured at a measuring angle of 60° with VG2000 gloss meter made by Nippon Denshoku Industries Co., Ltd. Here, the spacing d between the protruded part of the surface of the emboss roller 15 and the surface of the rubber 21 of the opposed roller 16 is set to 50 μm (Sample 1), 80 μm (Sample 2), 100 μm (Sample 3), 150 μm (Sample 4), and 200 μm (Sample 5), respectively, whereas the spacing d is set to 210 μm (Comparative example 1) and 40 μm (Comparative example 2) for comparison. Moreover, glossiness of the comparative example 3, the comparative example 4, and the comparative example 5 is also measured. In the comparative example 3, only the surface temperature of the emboss roller 15 is raised from 80° C. to 100° C. with respect to the comparative example 1. In the comparative example 4, only the pressure is raised from 9 MPa to 13.5 MPa with respect to the comparative example 1. In the comparative example 5, only the process speed is reduced from 10 mm/s to 5 mm/s with respect to the comparative example 1. The results are tabulated in the table 1. Furthermore, glossiness of unprocessed printing paper is also presented in the table 1 as a reference example.

TABLE 1

| | PROCESS | | | | GLOSSI- |
|---|---|---|---|---|---|
| | SPEED | PRESSURE | TEMP. | SPACING | NESS |
| | (mm/s) | (MPa) | (° C.) | d (μm) | (%) |
| SAMPLE 1 | 10 | 9 | 80 | 50 | 44 |
| SAMPLE 2 | 10 | 9 | 80 | 80 | 45 |
| SAMPLE 3 | 10 | 9 | 80 | 100 | 48 |
| SAMPLE 4 | 10 | 9 | 80 | 150 | 49 |
| SAMPLE 5 | 10 | 9 | 80 | 200 | 55 |
| COMPAR. | 10 | 9 | 80 | 210 | 80 |
| EX. 1 | | | | | |
| COMPAR. | 10 | 9 | 80 | 40 | X |
| EX. 2 | | | | | |
| COMPAR. | 10 | 9 | 100 | 210 | 78 |
| EX. 3 | | | | | |
| COMPAR. | 10 | 13.5 | 80 | 210 | 82 |
| EX. 4 | | | | | |
| COMPAR. | 5 | 9 | 80 | 210 | 80 |
| EX. 5 | | | | | |
| REF. | N/A | N/A | N/A | N/A | 81 |
| EXAMPLE | | | | | |

X denotes that it can not be passed through.

According to the table 1, glossiness is 4 to 55 when the spacing d is 50 to 200 μm (in the samples 1 to 5). Glossiness is 80 when the spacing d reaches 210 μm (in the comparative example 1), that is almost the same as 81 of the glossiness of the unprocessed print object, which is presented as a reference example. When the spacing d is 40 μm (in the comparative example 2), it becomes apparent that the paper can not be passed through therebetween. Moreover, it becomes apparent that glossiness is in a range of 78 to 82 as long as the spacing d is 210 μm even when process speed, pressure, or temperature is varied and that it is almost the same as that of the unprocessed print object.

Glossiness is preferably equal to or less than 60 in order that a desirable matt effect is visually observed. Accordingly, it becomes apparent that the distance d between the protruded part of the surface of the emboss roller 15 and the opposed roller 16 is preferably 50 μm to 200 μm, where glossiness reaches equal to or less than 60. From the above results, the distance d is set to within this range in this embodiment. Furthermore, rubber in this embodiment is 60° in hardness and 300 μm in thickness, but it is not limited to this. The rubber may be 35° to 70° in thickness, and also the rubber may be 200 μm to 800 μm in thickness.

Next, the pressure between the emboss roller 15 and the opposed roller 16 in an embodiment of the present invention will be described. First, the pressure at which glossiness in a desirable range can be accomplished is obtained from the following experiments. A printing paper having a thickness of about 220 μm to 250 μm is fabricated as a print object 2 by MEGAPIXEL III sublimation transfer printer made by ALTECH Co., Ltd. The printing paper is passed through and embossed in the emboss device 1 of the present invention with varying the pressure between the emboss roller 15 and the opposed roller 16 under a condition when radius of both rollers 15, 16 is 300 mm, the spacing between both rollers is 100 μm, type of the rubber wrapped around the opposed roller 16 is chloroprene, hardness of the rubber is 60° (JIS-A), process speed of the print object is 10 mm/s, surface roughness Ra of the emboss roller 15, Ra=8 μm, and surface temperature is 80° C. in a similar manner to the above experiments. The glossiness of the embossed print object 2 is measured at a measuring angle of 60° with VG2000 gloss meter made by Nippon Denshoku Industries Co., Ltd. with varying the pressure. From these results, it becomes apparent that, when the pressure is less than 8 MPa, the glossiness reaches equal to or more than 60 and is unsuitable for the printing paper. Moreover, it becomes apparent that, when the pressure is more than 14 MPa, the printing paper has uneven glossiness and can not be evenly embossed and that the glossiness is unsuitable for the printing paper. Accordingly, the pressure is elected to be 8 MPa to 14 MPa in this embodiment.

These pressure are accomplished when the spacing between both rollers is 100 μm, type of rubber is chloroprene, hardness of rubber is 60° (JIS-A), thickness of rubber is 200 μm to 500 μm. However, the spacing between both of the rollers may be 50 μm to 200 μm as long as the pressure is satisfied within a range of 8 MPa to 14 MPa. Moreover, rubber of other type or rubber with different hardness may be used. Table 2 shows calculated results of the thickness range of rubber for rubbers having different hardness, within the thickness range the above desirable pressure of 8 MPa to 14 MPa can be accomplished.

TABLE 2

| RUBBER HARDNESS | RUBBER THICKNESS RANGE |
|---|---|
| JIS-A | [μm] |
| 35 | 200 |
| 40 | 200 |
| 45 | 200~300 |
| 50 | 200~400 |
| 55 | 200~400 |
| 60 | 200~500 |
| 65 | 300~600 |
| 70 | 300~800 |

As shown in the table 2, rubber is preferably 200 μm to 800 μm in thickness when the rubber is 35° to 70° in hardness. Moreover, rubber is more preferably 200 μm in thickness when the rubber is 35° to 40° in hardness. Rubber is more preferably 200 μm to 300 μm in thickness when the rubber is 45° in hardness. Rubber is more preferably 200 μm to 400 μm in thickness when the rubber is 50° to 55° in hardness. Rubber is more preferably 200 μm to 500 μm in thickness when the rubber is 60° in hardness. Rubber is more preferably 300 μm to 600 μm in thickness when the rubber is 65° in hardness. Rubber is more preferably 300 μm to 800 μm in hardness when the rubber is 70° in hardness.

As described above, according to an embodiment of the present invention, the spacing d between the protruded part of the surface of the emboss roller 15 and the surface of the opposed roller 16 is equal to or less than 50 μm. Thus, it does not occur that the print object can not be passed through therebetween. Moreover, since the spacing d is equal to or less than 200 μm, it does not occur that the print object is insufficiently embossed and that thus glossiness is insufficiently reduced.

Moreover, an elastic member 21 is wrapped around the outer periphery of the opposed roller 16, and the elastic member is equal to or more than 200 μm in thickness. Accordingly, it does not occur that convexoconcave are unevenly imparted owing to insufficient elasticity. Moreover, since the elastic member is equal to or less than 800 μm in thickness, it does not occur that the print object is pressed against the emboss roller with insufficient pressing force owing to excess elasticity and that thus glossiness reaches equal to or more than 60.

Furthermore, in an embodiment of the present invention, the pressure applied to the print object 2 is equal to or more than 8 MPa. Accordingly, it does not occur that the glossiness of the print object reaches equal to or more than 60 owing to the insufficient pressing force of the print object against the emboss roller. Moreover, since the pressure applied to the print object is equal to or less than 14 MPa, it does not occur that the print object is damaged owing to excess pressing force or it does not occur that convexoconcave are unevenly imparted. Accordingly, glossiness can be evenly reduced.

As described above, glossiness of the print object is evenly reduced to a level equal to or less than 60 by the emboss device according to an embodiment of the present invention. Thus, a print object having a brilliant silky tone with moderated gloss can be obtained.

Furthermore, the emboss device 1 in this embodiment is not limited to the above form. Other components or the like may be modified appropriately, as long as the emboss device 1 includes an emboss roller and an opposed roller, and the spacing therebetween, the thickness of rubber, or the pressure between the rollers is satisfied within a prescribed range.

Furthermore, the emboss device 1 in this embodiment can be embodied by itself or as a printing system, for example by combining the emboss device 1 with a printer. In this case, the printer may also be configured as a sublimation transfer printer which forms image on an image receiving paper by thermally transferring ink on a transfer sheet to the paper. Then, the print object 2 which is formed by thermally transferring the image to the image receiving paper in the printer is fed to the emboss device 1. Thereafter, convexoconcave are imparted to the print object 2 in the process part 4. Moreover, the printing system may be configured in a manner that the control part can selectively impart convexoconcave to the print object 2 in accordance with the necessity of processing of the print object 2 formed by the printer. In this case, the print object 2 imparted with convexoconcave or the print object 2 without them can be obtained in accordance with the preference of a user.

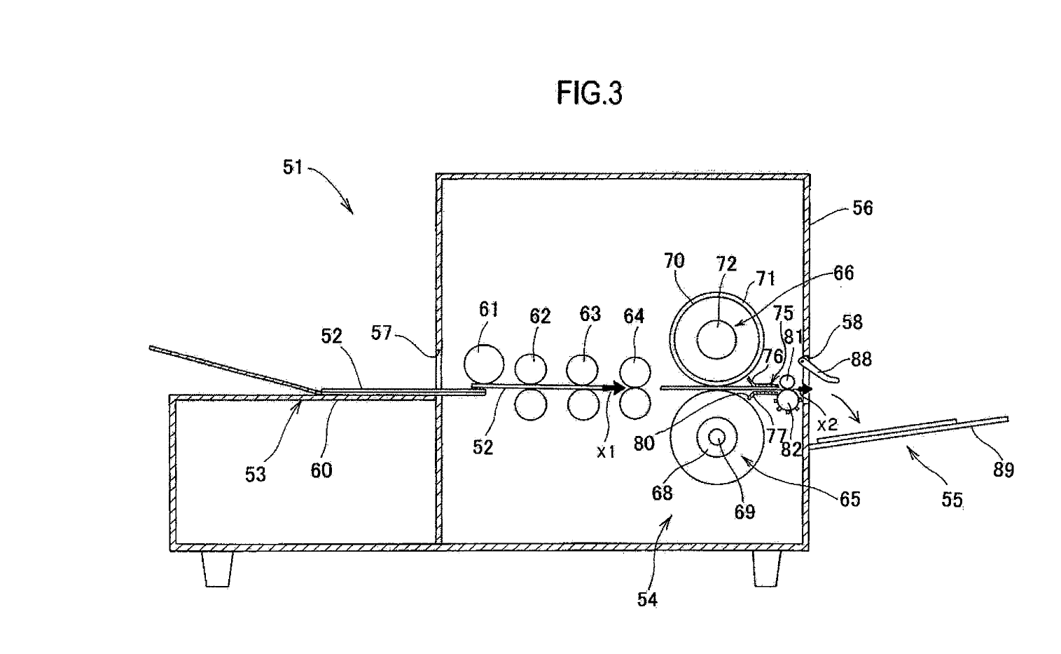

FIG. 3 shows a schematic view of an emboss device 51 according to another embodiment of the present invention. The emboss device 51 is a device of applying pressure to a sheet-like printing paper 52, which is a print object, so that convexoconcave are imparted to the surface of the printing paper 52. In this embodiment, the printing paper 52 is a photograph in which image is transferred to an image receiving sheet having paper as its base material and the surface of the sheet is covered with a protection layer. The emboss device 51 is a device of imparting convexoconcave to the protection layer side surface (image forming surface) of a printing paper 52, thereby to process the printing paper 52 into a matt condition with moderated gloss.

The emboss device 51 includes a holder 53 of holding unprocessed printing paper 52, a process part 54 of embossing the printing paper 52 conveyed from the holder 53, an ejection part 55 of ejecting the processed printing paper 52, and a chassis 56 of surrounding the process part 54. The chassis 56 is provided with an entry 57 and an exit 58.

The holder 53 includes a paper feed tray 60 able to hold multiple sheets of the printing paper 52 in a stacked form, and a pickup roller 61 of feeding out the printing paper 52 placed on the paper feed tray 60 one by one to the process part 54. It is noted that the pickup roller 61 is adapted to be rotated by a drive mechanism not shown in the figure.

The process part 54 includes pairs of convey rollers 62 and 63, a cleaning roller 64, an emboss roller 65, and an opposed roller 66 paired with the emboss roller 65. The pair of convey rollers 62 (63) sandwich a printing paper 52 fed by the pickup roller 61 of the holder 53 therebetween and further conveys the printing paper 52. The convey rollers 62 and 63 are rotated by drive mechanisms not shown in the figure. The cleaning roller 64 removes smear such as dust from the surface of the printing paper 2. The pair of the emboss roller 65 and the opposed roller 66 sandwich the printing paper 52 conveyed by these convey rollers 62, 63 and the cleaning roller 64 therebetween and emboss the printing paper 52.

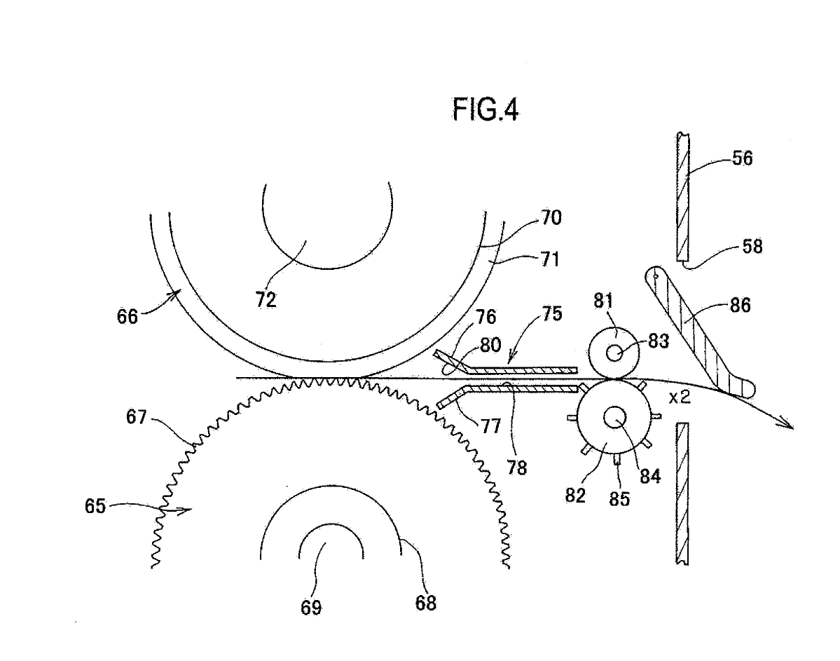

FIG. 4 is an enlarged view of a part from the emboss roller 65 and the opposed roller 66 to the ejection part 55. The emboss roller 65 is a cylindrical member formed of a hollow material made by aluminum or the like and has a surface on which convexoconcave 67 are formed as illustrated schematically in FIG. 3. Then, the rotation shaft 68 is loaded into the middle of the emboss roller 65 along its longitudinal direction. A heating mechanism 69 able to set the surface temperature within a prescribed range of temperature is provided inside the rotation shaft 68. The heating mechanism 69 includes a heating body such as a heater and can set the surface temperature of the emboss roller 65 by setting the heat amount of the heater appropriately. Furthermore, a drive mechanism not shown in the figure is connected to the emboss roller 65, and the emboss roller 65 is rotated by the drive mechanism.

The opposed roller 66 includes a cylindrical member 70 formed from aluminum or the like material and an elastic member 71 wrapped around the outer periphery of the cylindrical member in a similar manner to the emboss roller 65. The elastic member 71 used in this embodiment is rubber, but is not limited to rubber. It may be a member having cushioning properties. Moreover, a rotation shaft 72 is loaded into the opposed roller 66 along its longitudinal direction in a similar manner to the emboss roller 65. The rotation shafts 68,72 of the emboss roller 65 and the opposed roller 66 are secured to supporting plates (not shown) via bearings provided at both ends of both rollers 65,66 in a rotatable manner with respect to the supporting plates and in parallel to each other.

A curl preventing guide 75 extending along the feed direction of the printing paper 52 is disposed at the downstream side of the part of the process part 54 of imparting convexoconcave to the printing paper 52 which is between the emboss roller 65 and the opposed roller 66. The curl preventing guide 75 includes an upper flat plate 76 and a lower flat plate 77 which extend in parallel to each other. A gap 78 extending with a constant clearance is provided between the upper flat plate 76 and the lower flat plate 77. Moreover, the upstream end part of the upper flat plate 76 is doglegged upwardly, whereas the upstream end part of the lower flat plate is doglegged downwardly. Accordingly, the gap 78 is gradually stretched out toward the upstream side in the thickness direction of the printing paper 2 loaded thereinto, so that an insertion port 80 having a funnel-shape cross section is formed.

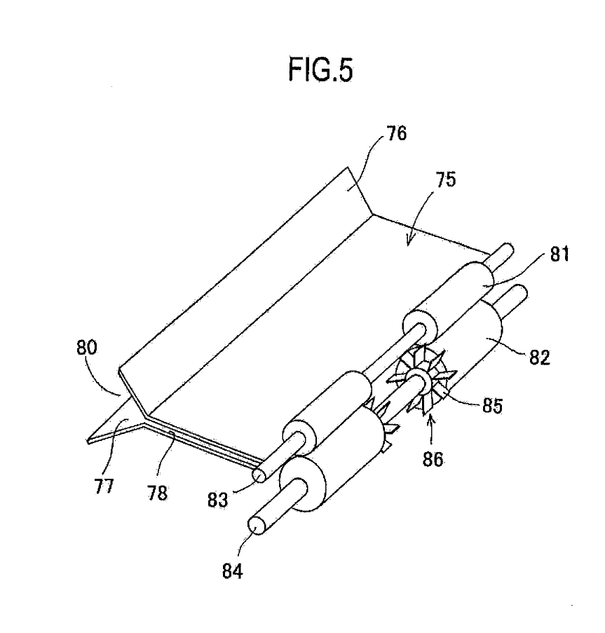

Moreover, upper convey rollers 81 and lower convey rollers 82 are also provided at the downstream end part of the upper flat plate 76 and the lower flat plate 77 as shown in FIG. 5. Each of the upper convey rollers 81 and each of the lower convey rollers 82 make a pair and sandwich and convey the printing paper 52 therebetween. Two pair of the upper convey roller 81 and the lower convey roller 82 are disposed in a direction perpendicular to the feed direction of the printing paper 52 and in parallel to both of the flat plates. Each of the upper convey rollers 81 and each of the lower convey rollers are adapted to rotate around the same axes 83, 84, respectively. Moreover, paddles 86 having impellers 85 extending radially from the same axis 84 of the lower convey rollers 82 are attached to the opposing end part of two lower convey rollers 82.

Then, a door 88 is provided at the exit 58 of the chassis 56 of the emboss device 51 as shown in FIG. 3 and FIG. 4. The door 88 is swung to open when the print object is passed therethrough. Furthermore, a paper eject tray 89 extending outwardly is attached to the chassis 56 at its lower part outside the door 88.

Next, the operation of the emboss device 51 will be described. First, printing paper 52 is placed on the paper feed tray 60 of the holder 53 with its protection layer side (image forming surface) down. Accordingly, the print object 52 is held in a manner that a part of the print object 52 is inserted from the entry 57 into the interior of the chassis 56 as described above. When the emboss device 51 is in operation, the pickup roller 61 is rotated in contact with the printing paper 52 so that the printing paper 52 is fed one by one to the process part 54 inside the chassis 56. The printing paper 52 conveyed to the process part 54 is conveyed by pairs of convey rollers 62 and 63 rotated by drive mechanisms, during which dust or the like is removed from the back side of the printing paper 52 by the cleaning roller 64. Then, the printing paper 52 is fed along the arrow x1 into between the emboss roller 65 and the opposed roller 66. When the printing paper 52 passes through between the emboss roller 65 heated by the heating mechanism 69 and the opposed roller 66, minute convexoconcave are imparted to the surface of the printing paper 52 by the convexoconcave 67 on the surface of the emboss roller 65.

In this processing, the emboss roller 65 is heated as described above in order that convexoconcave are well imparted. Accordingly, the printing paper 52 is also in a heated condition just after it is processed by the emboss roller 65. The printing paper 52 in this heated condition is inserted into the gap 78 provided between the upper flat plate 76 and the lower flat plate 77 of the curl preventing guide 75. In this case, the upstream end part of the gap 78 of the curl preventing guide 75 is stretched out in the thickness direction of the printing paper 52 and thus the insertion part 80 is formed. Accordingly, the printing paper 52 can be easily guided into the gap 78 even if it is somewhat curled.

Then, the printing paper 52 guided into the gap 78 is further fed in the gap 78 to the downstream side by the rotations of the emboss roller 65 and the opposed roller 66. The vertical width of the gap 78 in the thickness direction of the printing paper 52 is narrow, and thus the printing paper 52 can not be curled while it is cooled down. Accordingly, the printing paper 52 is fixed with its flat condition maintained in a process of naturally cooled down.

Then, the printing paper 52 fixed in the flat condition is sandwiched between the upper convey roller 81 and the lower convey roller 82 at the downstream side of the curl preventing guide 75, and further fed to the downstream side by the rotations of these rollers. In this case, the middle portion of the printing paper 52 is heaved a little by the impellers 85 of the paddles 86. The printing paper 52 is fed out to the downstream side along the arrow x2, pushes against the door 88, and is conveyed to the outside of the chassis 56. The printing paper 52 is fallen down onto the paper eject tray 89 and held on the paper eject tray 89 in a sequentially stacked form.

As described above, in the emboss device 51 according to another embodiment of the present embodiment, the printing paper 52 is fed to the gap 78 having a narrow clearance after it is heated in embossing but before it is cooled down. Since the printing paper 52 is cooled down in the gap 78 with its flat condition maintained, the printing paper 52 can not be curled. Accordingly, the embossed printing paper 52 without skew and curl can be obtained.

Next, holding of the printing paper 52 on the paper eject tray 89 will be described. Since the printing paper 52 is in some heated condition after it is ejected on the paper eject tray 89, the shape of the printing paper 52 held thereon during this heated condition can be permanently fixed. Namely, when the printing paper 52 is held in its curled shape on the paper eject tray 89, the printing paper 52 can curled even if curl is prevented by the curl preventing guide 75. In this circumstances, the curl of the printing paper 52 is corrected by the weight of itself on the paper eject tray 89. In a case that the middle portion of the ejected printing paper 52 is curled convexedly with respect to a placing surface for the printing paper 52 of the paper eject tray, the curl correcting effect by the own weight of the printing paper 52 is greater than that in a case that the middle portion of the printing paper 52 is curled concavely. Furthermore, curl can also be adjusted by adjusting the rotation speeds of the emboss roller 65 and the opposed roller 66.

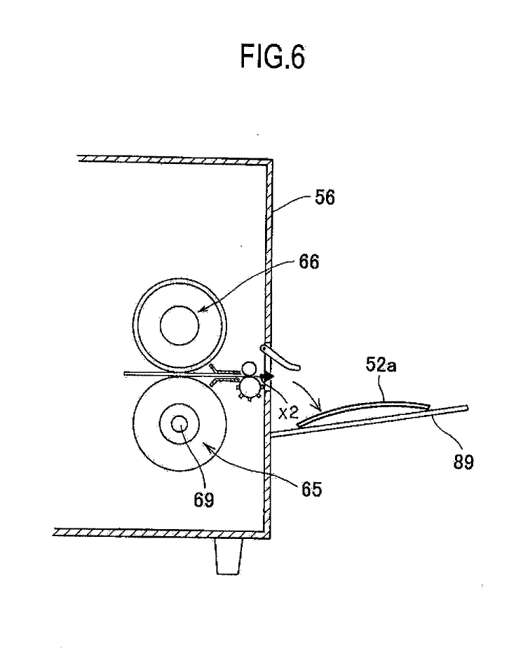

As shown in FIG. 6, when the emboss roller 65 is arranged on the lower side and the opposed roller 66 is arranged on the upper side, the heating mechanism 69 inside the emboss roller 65 is disposed on the lower side. Accordingly, the image printing surface of the printing paper is shrunk by the heat of the heating mechanism 69, and thus the printing paper 52a with its middle portion convexed is ejected out onto the paper eject tray 89. Here, curl can be corrected on the paper eject tray 89. Furthermore, when the emboss roller 65 is regulated to rotate faster than the opposed roller 66, a drag in rotation is generated at the contacting part between the emboss roller 65 and the opposed roller 66, and thus curl is adjusted in a manner that the middle portion of the printing paper 52 becomes more convexed. This is effective when the middle portion of the printing paper 52 is concaved prior to passing through between the emboss roller 65 and the opposed roller 66, for example. As for regulating the rotation speeds of the emboss roller 65 and the opposed roller 66, the opposed roller 66 to which a rotation torque is burden may be rotated in a coupled manner with the rotation of the emboss roller 65, or the opposed roller 66 may also be provided with a drive mechanism, for example. Furthermore, even in the configuration where the emboss roller 65 and the opposed roller 66 rotate at the same speed, the image printing surface of the printing paper is shrunk by the heat of the heating mechanism 69 and thus the middle portion becomes convexed, so that curl of the printing paper 52a is corrected by its own weight.

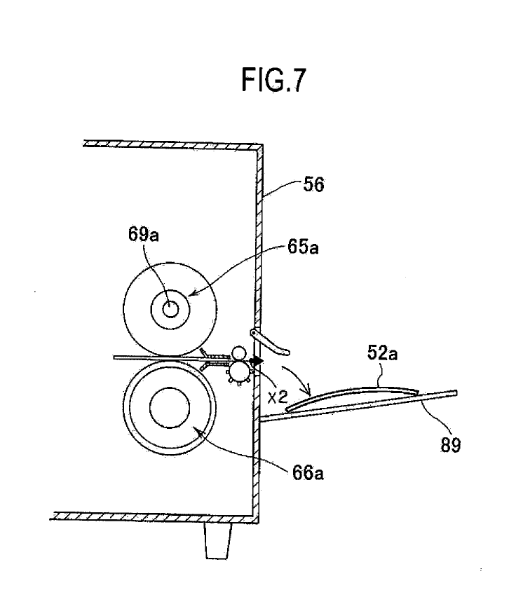

In the above embodiment, the printing paper 52 is held on the paper eject tray 89 in a manner that the image printing surface to be embossed is at the under side thereof. However, the printing paper 52 may be held on the paper eject tray 89 as shown in FIG. 7 in a manner that the emboss roller 65a is arrange on the upper side and the opposed roller 66a is arranged on the lower side and that the image printing surface of the printing paper 52 is at the upper side thereof. The middle portion of the printing paper 52 ejected out onto the paper eject tray 89 can be convexed in some cases depending on the properties of the printing paper 52 even in the configuration in which the emboss roller 65a is arranged on the upper side with respect to the opposed roller 66. For example, when the middle portion of the printing paper 52 is strongly curled in a convexed manner prior to passing through between the emboss roller 65a and the opposed roller 66a, the image printing surface of the printing paper 52 is shrunk by the heat of the heating mechanism 69a, and thus the printing paper 52a with moderated curl is ejected out onto the paper eject tray 89. In this way the device is effective in correcting curl of the printing paper 52. Even in this case, curl of the printing paper 52 can be further corrected by regulating the rotation speeds of the emboss roller 65a and the opposed roller 66a in a similar manner to the above example.

Furthermore, the curl preventing mechanism of the emboss device 51 according to another embodiment of the present invention is not limited to the above form of including two flat plates. For example, the curl preventing mechanism may also be provided with a gap having a constant width provided inside a solid block. Moreover, the conveying mechanism of the printing paper 52 does not have to be a sandwiching mechanism with convey rollers, it may also be a mechanism of conveying with a conveyer or the like, for example.

Furthermore, the emboss device 51 according to another embodiment of the present invention can be embodied by itself or as a printing system, for example, by combining the emboss device 51 with a printer. In this case, the printer may also be configured as a sublimation transfer printer which forms image on an image receiving paper by thermally transferring ink on a transfer sheet to the paper. Then, the printing paper 52 which is formed by thermally transferring the image to the image receiving paper in the printer is fed to the emboss device 51. Thereafter, convexoconcave are imparted in the process part 59. Moreover, the printing system may be configured in a manner that the control part can selectively impart convexoconcave to the printing paper 52 in accordance with the necessity of processing of the printing paper 52 formed by the printer. In this case, the printing paper 52 imparted with convexoconcave or the printing paper 52 without them can be obtained in accordance with the preference of a user.

1. An emboss device, comprising:
an emboss roller having a surface on which convexconcave and formed; and
an opposed roller arranged oppositely to the emboss roller, wherein
the emboss roller and the opposed roller sandwich a sheet-like print object therebetween, thereby to impart the print object with convexoconcave, and
the spacing between the protruded part of the surface of the emboss roller and the surface of the opposed roller is 50 μm to 200 μm.

2. The emboss device according to claim 1, wherein
the opposed roller comprises a cylindrical member and an elastic member wrapped around the outer periphery of the cylindrical member,
the elastic member is 35° to 70° in hardness and 200 μm to 800 μm in thickness, and
the print object is 220 μm to 250 μm in thickness.

3. An emboss device comprising:
an emboss roller having a surface on which convexoconcave are formed; and
an opposed roller arranged oppositely to the emboss roller, wherein
the emboss roller and the opposed roller sandwich a sheet-like print object therebetween, thereby to impart the print object with convexoconcave,
the opposed roller comprises a cylindrical member and an elastic member wrapped around the outer periphery of the cylindrical member, and
the elastic member is 200 μm to 800 μm in thickness.

4. The emboss device according to claim 3, wherein the elastic member is 50° to 70° in hardness and 200 μm to 500 μm in thickness.

5. The emboss device according to claim 3, wherein
the spacing between the protruded part of the surface of the emboss roller and the surface of the elastic member wrapped around the opposed roller is 50 μm to 200 μm, and
the print object is about 200 μm to 250 μm in thickness.

6. An emboss device, comprising:
an emboss roller having a surface on which convexoconcave are formed; and
an opposed roller arranged oppositely to the emboss roller, wherein
the emboss roller and the opposed roller sandwich a sheet-like print object therebetween, thereby to impart the print object with convexoconcave,
the emboss device is configured in that the pressure applied to the print object is 8 Mpa to 14 Mpa when the print object is sandwiched between the emboss roller and the opposed roller.

7. The emboss device according to claim 6, wherein
the opposed roller comprises a cylindrical member and an elastic member wrapped around the outer periphery of the cylindrical member,
the spacing between the protruded part of the surface of the emboss roller and the surface of the elastic member is 50 μm to 200 μm,
the elastic member is 50° to 70° in hardness, and
the print object is about 220 μm to 250 μm in thickness.

8. An emboss device, comprising:
an emboss roller having a surface on which convexoconcave are formed and a heating device; and
an opposed roller arranged oppositely to the emboss roller,
wherein the emboss roller heated by the heating device and the opposed roller sandwich a sheet-like print object therebetween, thereby to impart the print object with convexoconcave, the emboss device comprising:
a curl preventing guide provided with a gap at the downstream side of a part between the emboss roller and the opposed roller with respect to a feed direction of the print object, the part imparting convexoconcave to the print object, wherein
the gap extends along the feed direction of the print object, and the print object is loaded into the gap in a substantially flat condition.

9. The emboss device according to claim 8, wherein the gap stretches out in the thickness direction of the print object loaded into the gap at an upstream end thereof.

10. The emboss device according to claim 8, wherein
the curl preventing guide comprises two flat plates extending in parallel to each other along a feed direction of the print object, and
the gap is formed from a gap between the two flat plates.

11. The emboss device according to claim 8, wherein
a paper eject tray of holding a print object ejected from the curl preventing guide is disposed at the downstream of the curl preventing guide with respect to a feed direction of the print object, and
the paper eject tray holds print object curled in a manner that the middle portion of the print object protrudes with respect to a placing surface of the paper eject tray.
